(19) United States
(12) Patent Application Publication
(10) Pub. No.: US 2016/0001916 A1
(43) Pub. Date: Jan. 7, 2016

(54) METHOD TO FORM A STACKING SHOULDER INTO THE SIDEWALL OF A CUP WITH A ROTATING TOOL

(71) Applicant: Huhtamäki Oyj, Espoo (FI)

(72) Inventors: Philip Walker, Fareham (GB); Tim Yeomans, Locks Heath (GB)

(21) Appl. No.: 14/754,032

(22) Filed: Jun. 29, 2015

(30) Foreign Application Priority Data
Jul. 4, 2014 (EP) 14175838.3

(51) Int. Cl. B65D 1/40; A47G 19/22; B65D 21/02; A47G 19/03; B31D 5/02; B31B 43/00

(52) U.S. Cl. CPC B65D 1/40; B31D 5/02; B31B 43/00; B65D 21/0233; A47G 19/03; A47G 19/2205

(57) ABSTRACT

The present invention relates to a method for the production of a container having a bottom and a first sidewall attached to the bottom, wherein a stacking shoulder is formed into the first sidewall by means of a form tool and a mandrel, wherein the fowl tool reciprocates along its center axis from a remote position to a forming position.

### CROSS-REFERENCE TO RELATED APPLICATIONS

This Application claims priority to European Patent Application Number 14175838.3 filed Jul. 4, 2014, to Philip Walker et al., currently pending, the entire disclosure of which is incorporated herein by reference.

### FIELD OF THE INVENTION

The present invention relates to a method for the production of a container having a bottom and a first sidewall attached to the bottom, wherein a stacking shoulder is formed into the first sidewall by means of a form tool and a mandrel, wherein the form tool reciprocates along its center axis from a remote to a forming position.

### BACKGROUND OF THE INVENTION

A method is well known in the state of the art and utilized to produce a container, for example a cup, with at least a first sidewall and bottom. In most cases, the two edges of a blank, from which the inner sidewall is formed into a cylindrical or conical shape, overlap and are connected to each other, for example glued together, by a side seam. In many cases, a stacking shoulder is formed into the sidewall, on which a second cup, which is inserted into the first cup, rests. The stacking means improve the destacking of the cups, prior to their use. The method according to the state of the art has, however, the disadvantage, that the stacking shoulder does not have a sharp, well defined contour and/or that the side seam leaks particularly in the region of the stacking shoulder.

### SUMMARY OF THE INVENTION

One objective of the present invention is to provide a method to produce a container, which does not comprise the deficiencies according to the state of the art.

This objective may be attained by a method for the production of a container having a bottom and a first sidewall attached to the bottom, wherein the sidewall preferably comprises a rolled rim at its upper edge opposite to the bottom, wherein a stacking shoulder is formed into the first sidewall by means of a form tool and a mandrel, wherein the form tool reciprocates along its center axis from a remote to a forming position and wherein the form tool rotates around the center axis at least temporarily during forming of the stacking shoulder.

The present invention relates to the production of a container, particularly a cup, which can be used to serve hot or cold drinks. The container comprises a bottom and a sidewall, wherein the bottom is connected to one end of the sidewall, while the other end is open. At the other end, the sidewall may comprise a rim, particularly a rolled rim. The sidewall of the cup is produced from a blank of material, which is subsequently rolled into, for example, a cylindrical or conical shape. Subsequently, two edges of the blank, which preferably overlap, are connected to each other, for example by gluing and/or sealing. Hence a side seam is produced which extends over the entire axial length of the first sidewall. The container can be made from any suitable material, which is particularly food grade. Examples for suitable materials are paper, carton, plastic, PLA, a renewable and/or a biodegradable material and/or any other comparable material.

According to one embodiment of the present invention, the sidewall comprises a stacking shoulder, which is formed into the first sidewall by means of a form tool and a mandrel, wherein the sidewall is wrapped around the mandrel and the form tool reciprocates between a remote position and a forming position. In the forming position, forming means, for example an edge in the form tool can cooperate with forming means at the mandrel and hence form the stacking the shoulder into the sidewall of the cup.

According to one embodiment of the present invention, the form tool rotates at least temporarily, preferably continuously during forming of the stacking shoulder around its center axis. In one embodiment, the faun tool never stops rotating. Once the machine starts, the form tool constantly rotates in the same direction. Due to this rotation, a much better defined stacking shoulder, with better defined edges may be produced and the resulting container performs better during leak testing, because the side seam is not damaged during the forming of the stacking shoulder. Furthermore, there may be a reduced load required to push the form tool up the cup to create the stacking shoulder. The rotation allows the tool to include the side seam without the tooling locking on the cup. The form tool can be simplified in comparison to tools according to the state of the art, for example EP 1 227 043 A1, because no indentation in the mandrel or the form tool is needed in the vicinity of the side seam. The same form tool pushed up the cup without being rotated was often impossible to pull back off due to the side seam. The rotation also allows the tool to move up the cup easier. There is less risk of dragging the material of the sidewall of the container; in effect the tooling moves over the top of the material a lot smoother. Due to the rotation of the form tool, there is not only a linear but also a tangential movement of the form tool during forming of the stacking shoulder.

The mandrel can be static during the formation of the stacking shoulder. Particularly, the mandrel may not rotate.

According to one embodiment of the present invention, the form tool rotates continuously, preferably at between about 400-1000 rpm, more preferably at between about 500-900 rpm and even more preferred at between about 600-800 rpm.

The two edges of the first side wall can be attached to one another by a side seam, wherein the two edges of the sidewall overlap.

Preferably, the direction of rotation is against the outer edge of the side seam, i.e. against the winding direction of the material, of the side wall being made.

A second sidewall can be attached to the first sidewall. The axial length of this second sidewall may be smaller than the axial length of the first sidewall. The second sidewall may not be flat, but can comprise a 3-dimensional shape, so that gaps, filled with air, are provided between the first and the second sidewall. These gaps provide insulation and/or improve the gripping of the container.

According to one embodiment of the inventive method, the form tool moves into the first sidewall at high speed, dwells for a small period of time in this position and then retracts again at high speed. The form tool may rotate continuously during the entire inventive method.

Another subject matter of the present invention is a container, preferably a cup producible according to the inventive method.

Other and further objects of the invention, together with the features of novelty appurtenant thereto, will appear in the course of the following description.

### DESCRIPTION OF THE SEVERAL VIEWS OF THE DRAWING

The inventions are now described in further detail according to FIGS. 1 to 5. These explanations do not limit the scope of protection. The description applies to all subject matters of the present invention likewise.

FIG. 1 is a fragmentary sectional side view of two cups stacked together in accordance with one embodiment of the present invention;

FIG. 1A is an enlarged sectional view of a portion of the cups in balloon A of FIG. 1;

FIG. 2 is a fragmentary sectional side view of two cups stacked together in accordance with another embodiment of the present invention;

FIG. 2A is an enlarged sectional view of a portion of the cups in balloon B of FIG. 2;

FIG. 3A is a partial side perspective view of a mandrel in accordance with one embodiment of the present invention;

FIG. 3B is a side perspective view of a form tool in accordance with one embodiment of the present invention;

FIG. 4A is a sectional side perspective view of a form tool, mandrel and cup, illustrating the form tool moving from a remote position to a forming position in accordance with one embodiment of the present invention;

FIG. 4B is a sectional side perspective view of a form tool, mandrel and cup, illustrating the first sidewall of the cup being deformed in accordance with one embodiment of the present invention;

FIG. 4C is a sectional side perspective view of a form tool, mandrel and cup, illustrating the form tool moving from a forming position to a remote position in accordance with one embodiment of the present invention; and

FIG. 5 is a partial schematic sectional view of a cup first sidewall illustrating an overlapping side seam in accordance with one embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

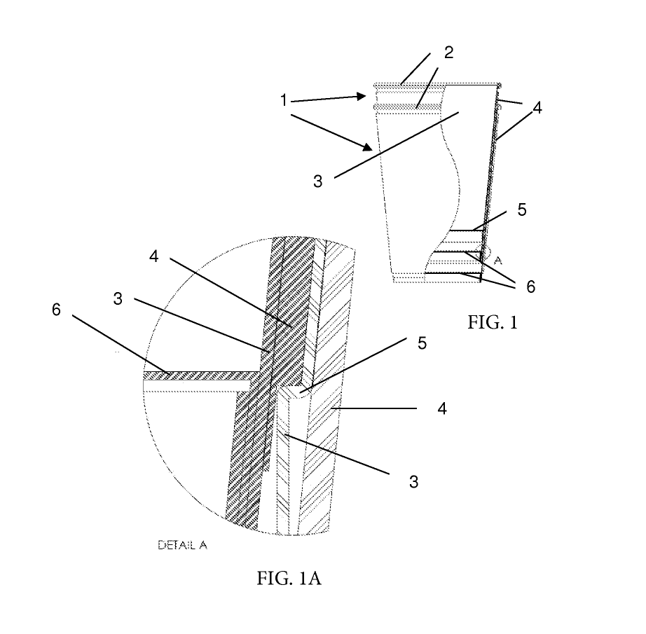

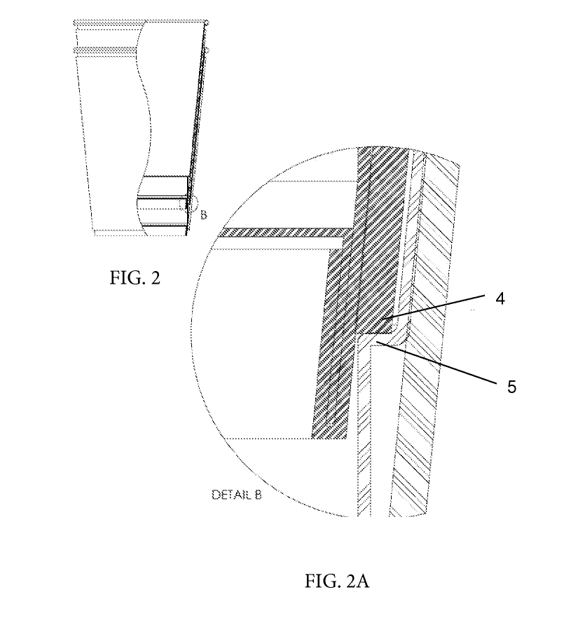

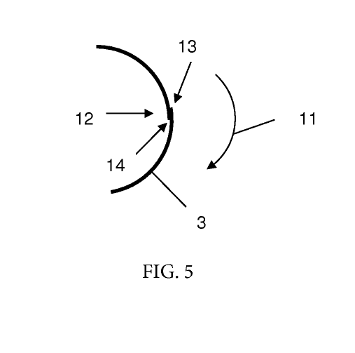

FIGS. 1 and 2 show two cups 1 stacked together; i.e. one cup is inserted into another cup. Each cup comprises in the present case a first, here inner sidewall 3, which is optionally provided with a rolled rim 2 at its upper edge. At the opposite edge, a bottom 6 is connected to sidewall 3, for example by gluing and/or sealing. The inner sidewall 3 is produced from a blank, which is rolled around a mandrel and hence brought into its here conical shape. As can be particularly seen from FIG. 5, two edges of the sidewall 3, which overlap, are connected to each other by a side seam 14. Around the first sidewall 3 a second sidewall 4 may be provided. This second sidewall 4 may be smaller, i.e. comprises a smaller axial extension than the first sidewall. The second sidewall can comprise a 3-dimensional shape, so that air gaps may be formed between the first and the second sidewall. As already mentioned, particularly during transportation and prior to their use the cups 1 are stacked together; i.e. one cup is inserted into another cup. In order to improve destacking prior to use, the first sidewall 3 comprises a stacking shoulder 5 on which here the sidewall of the inserted cup rests. In one embodiment, the second sidewall 4 rests partially on the stacking shoulder 5 and consequently limits the extent by which the upper cup can be inserted into lower cup and hence improves destacking. Contrary to the embodiment according to FIG. 1, in the embodiment according to FIG. 2, the second sidewall may rest entirely on the stacking shoulder 5.

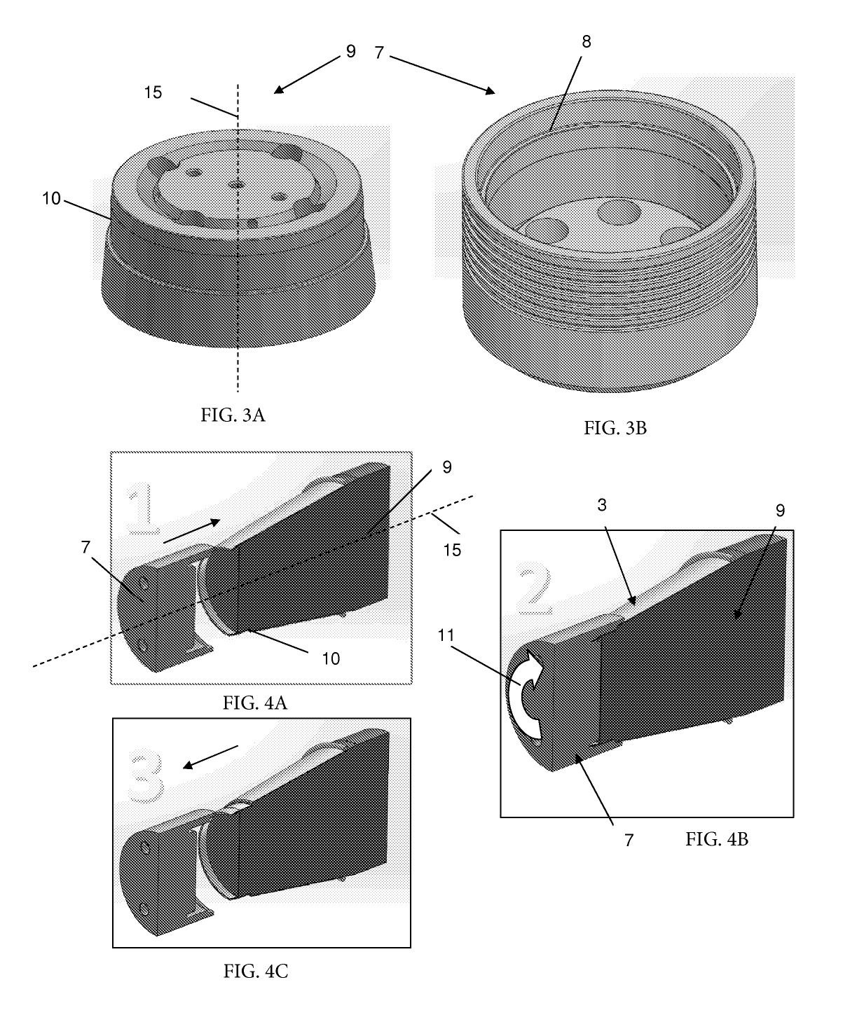

FIG. 3B shows the form tool 7, which is utilized to insert the stacking shoulder 5 into the first sidewall 3. In the present case, this form tool 7 may be provided with a continuous, circular shape. As can be particularly seen from FIG. 3B, on its inner surface, the form tool 7 comprises forming means 8, here in the shape of a step, which cooperates with a corresponding forming means at the mandrel 9, as can be seen from FIG. 3A and thus forms the stacking shoulder 5. The step 8 extends around the entire circumference of the inner circumference of the form tool 7.

Reference is now made to FIGS. 4A-4C, which shows the three productions steps for the formation of the stacking shoulder 5 according to one embodiment of the present invention. As already mentioned, for the formation of a stacking shoulder 5, a mandrel 9 is provided, which can be stationary and around which the material of the first sidewall 3 is wrapped. This mandrel 9 comprises at its lower end means 10, here an indentation, which is utilized to form the stacking shoulder 5. The indentation 10 typically extends continuously around the entire outer circumference of the mandrel 9. In a first step, depicted in FIG. 4A, the form tool 7 is displaced from the depicted remote position to its forming position, which is depicted in FIG. 4B. In this position, the forming means 8 of the form tool 7 cooperate with the forming means 10 of the mandrel 9 and hence deform the sidewall 3 of the cup plastically, so that it comprises the stacking shoulder 5. As depicted by arrow 11, the form tool 7 rotates at least while it is in its forming position. However, it will be appreciated, that the forming tool 7 may rotate continuously, even in its remote position. In one embodiment, the speed of rotation is between about 600 and about 800 rpm. The forming tool 7 may remain in its forming position only for a very small period of time and is then moved back into its remote position as depicted in FIG. 4C.

FIG. 5 shows schematically the first sidewall 3 and its overlap region 12, in which the edges of the sidewall 3 are attached to one another by the seam 14. Also shown schematically is the rotation of the form tool 7 depicted by arrow 11. It can be clearly seen, that according to an embodiment of the inventive method, the direction of rotation, here clockwise, is against the outer edge 13 of the side seam 14.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for producing a container having a bottom and a first sidewall attached to the bottom, wherein a stacking shoulder is formed into the first sidewall, the method comprising the steps of:
providing a form tool and a mandrel;
moving the form tool from a remote position to a forming position; and
rotating the form tool around a central axis at least temporarily during a forming of the stacking shoulder.

2. The method according to claim 1, wherein the mandrel is static.

3. The method according to claim 1, wherein the form tool rotates continuously between about 400 rpm and about 1000 rpm.

4. The method according to claim 1, wherein the foam tool rotates continuously between about 500 rpm and about 900 rpm.

5. The method according to claim 1, wherein the form tool rotates continuously between about 600 rpm and about 800 rpm.

6. The method according to claim 1, wherein two edges of the first sidewall are overlapped and attached to each other by a side seam.

7. The method according to claim 6, wherein a direction of rotation of the form tool is against an outer edge of the side seam.

8. The method according to claim 1, wherein a second sidewall is attached to the first sidewall.

9. The method according to claim 1, wherein the form tool moves into the first sidewall, dwells around the first sidewall, and then retracts from the first sidewall.

10. A container produced by the method of claim 1.
